(19) United States
(12) Patent Application Publication
(10) Pub. No.: US 2003/0164582 A1
(43) Pub. Date: Sep. 4, 2003

(54) Colouring process for ceramic materials

(76) Inventors: Graziano Vignali, Sasso Marconi (IT); Frabrizio Guizzardi, Bologna (IT)

Correspondence Address: Abelman Frayne & Schwab, 150 East 42nd Street, New York, NY, 10017, US

(21) Appl. No.: 10/333,765

(22) PCT Filed: Jul. 18, 2001
(86) PCT No.: PCT/EP01/08299

(30) Foreign Application Priority Data
Aug. 1, 2000 (IT) MI2000A001787

(51) Int. Cl. B05D 3/02; C04B 33/34

(52) U.S. Cl. 264/602; 427/376.2; 264/601; 428/454

(57) ABSTRACT

Process for colouring with pink/orange shades on surface and to a variable depth manufactured items obtained from a ceramic mass added with zinc oxide in an amount of 5% to 20% by weight, or with zinc silicate, said process uses a composition being in form of an aqueous or hydroalcoholic solution comprising Cr organic derivatives or inorganic salts alone or in combination with Fe organic derivatives or inorganic salts and/or Zn organic derivatives or inorganic salts, which is applied by controlled absorption onto the surface of the ceramic body before its firing in an oven according to a standard ceramic cycle.

### FIELD OF THE INVENTION

The present invention relates to a new colouring composition and to the related process of application onto ceramic supports.

In particular, the composition according to the invention consists of an aqueous or hydroalcoholic solution of chrome or iron/chrome inorganic salts or organic derivatives, possibly in combination with aqueous or hydroalcoholic solutions of zinc inorganic salts or organic derivatives, suitable to be applied onto stoneware ceramic supports added with zinc oxide or zinc silicate, so as to obtain new color shades on surface and in depth.

### STATE OF THE ART

The word stoneware indicates a particular group of ceramic products characterized by the presence of one or more crystal phases immersed in a main glass phase; the peculiarity of stoneware is its very low water absorption value, which should be lower than 0.5%. Glazed stoneware represents a particular type of stoneware, in which the technical features of the finished ceramic item substantially reminds the ones of porcelain.

In nature there are no individual raw materials (clays) already showing in their natural state all the features required to obtain stoneware, and it is therefore always necessary to prepare mixtures of various components. Raw materials commonly used belong to different mineral groups, each of them exerting a specific influence onto the mixtures. A typical mixture composition for stoneware is the following:

| Raw materials | Comp. % |
|---|---|
| Plastic and non-plastic clays | 40-50 |
| Feldspar | 30-40 |
| Quartz | 10-15 |

Clay materials provide the structure and plastic features of the raw material, i.e. its formability, and its resistance before and after firing. Feldspar is the melting element responsible for the high degree of vitrification of the final product. Quartz represents the basic matrix of the crystal phase in the finished product and is used in the mixture to balance the presence of melting components.

The quantitative relations between clay components, melting components and quartz depend on the intrinsic mineralogical nature of the clays, on the particle granulometry and on the firing cycle used. The typical composition disclosed above relates to a mixture suitable for fast firing. This expression refers to stoneware firing cycles lasting 40/70 min. with a maximum temperature of 1180-1230° C. A typical chemical analysis of a stoneware mixture is shown in the table below:

| | Oxides | | | | | | | |
|---|---|---|---|---|---|---|---|---|
| | SiO₂ | Al₂O₃ | TiO₂ | Fe₂O₃ | CaO | MgO | K₂O | Na₂O |
| Comp. % | 60-70 | 15-25 | 0.1-0.5 | 0.1-0.5 | 0.1-1.0 | 0.01-0.8 | 0.4-5.0 | 0.2-5.0 |

The peculiarity is the low concentration of colouring oxides such as Fe₂O₃ and TiO₂, so as to avoid obtaining a darkening of the white shade of said mixture.

For the colouring of ceramic manufactured items, and of stoneware in particular, several colouring pigments and several colouring processes have been developed since a long time in order to obtain products with a high aesthetic value. Among the most commonly used methods let us quote the one based on the addition of powder colouring pigments (in particular inorganic oxides and mineral colours) to the ceramic mixture before forming. The product is thus coloured for its whole thickness, though with a high consumption of colour, which is the most expensive component.

Keeping in mind that colouring is useless within the ceramic body, since said material is not transparent, it is obvious that methods have been searched which allow to obtain colouring only on the ceramic surface, with a high saving on expensive material.

Therefore, deposition systems of colouring pigments directly onto the surface of the ceramic body, before pressing and firing, have been provided. This system allows to obtain a consistent basic layer, around 75% of the product thickness, providing the structure of the tile, and to deposit onto said layer a coloured layer whose thickness can be adjusted at will and which does not affect the structural features of said product. The coloured layer, generally with a thickness of 1-2 mm, can also undergo further processes (smoothing, polishing). These technologies enable a strong saving on material, since only a thin layer of the product is coloured, but the application process is quite complex since it calls for the use of complex devices which can add and supply to the forming moulds the types and amounts of colouring pigments necessary to obtain the desired products. For this reason line productivity is compromised and besides said technology does not allow to obtain aesthetically complex products.

An alternative process for stoneware decoration consists in making the surface of the ceramic material, both after partial firing (as described for instance in DE 20.12.304) and after forming and before firing (as described for instance in CH 575.894), absorb an aqueous solution of metal salts which can turn into stable colouring products at high temperatures during the firing stage of the ceramic manufactured item. The aqueous solution is applied with known methods, such as dipping, spraying, disking, serigraphy. The use of soluble salts is particularly advantageous since it allows to obtain very thin coloured layers and it is often used for flat objects (such as flooring or facing tiles). In particular, serigraphic methods are extremely widespread because they allow to obtain graphic works, drawings and decorations which could not be carried out in any other way, with a limited use of colour. As far as the final aesthetic effect is concerned, decoration with soluble salts by serigraphy allows to obtain drawings and decorations with shaded contours, thus making it possible to carry out complex graphic works without compromising line productivity.

In recent years a series of colouring products has been developed, in which inorganic salts of chromofore metals (chlorides, nitrates, sulphates), which were present in the first soluble salts for decorations on ceramic materials, have been gradually replaced with metals in form of organic derivatives which, though maintaining the same chromofore effect, ensure a lower environmental impact. Inorganic anions, which were turned into corrosive highly polluting gases during firing at high temperatures typical of ceramic materials, have thus been replaced with organic anions turning by combustion into H₂O and CO₂. Alkaline or ammonium chloride, nitrate, sulphate in case present in the aqueous solution do not cause remarkably evolution of corrosive gas or vapours during firing.

The use of metal derivatives in aqueous solution allows to obtain a good colour penetration into the ceramic body. Colour penetration is a particularly important parameter to obtain smooth tiles. Smooth tiles are tiles whose surface portion has been removed by abrasion with diamond wheels for a thickness of 0.7 to 1.5 mm, which are then smoothed and polished with suitable felts until they have a perfectly polished surface. Therefore, it is obvious that it is necessary to obtain a colour penetration of at least 0.2 mm above the thickness removed by smoothing. Patent no. EP 704.411 describes for instance a process for colouring ceramic manufactured articles for a depth of 2 mm, characterized in that it uses aqueous solutions of ruthenium organic derivatives.

Though quite broad, the chromatic range which can be obtained with soluble organic salts is not complete, differently from what occurs for the colours obtained by using solid inorganic pigments (see for instance Biffi, “II gres porcellanato”, 1997, pages 89-94).

In order to obtain a yellow color with soluble salts various colouring compositions are known. Patent application no. EP940379 describes compositions for colouring ceramic materials on surface and to a depth of at least 1 mm, characterized in that they contain chrome and titanium organic derivatives in combination with antimony or tungsten organic derivatives, and their mixtures. Said solutions allow to obtain colours from yellow to orange according to the relations between the components. Colouring methods for ceramic materials have been recently developed, providing for the addition of oxides to the pastes, in particular TiO₂, which, though reducing the white shade of the support, can develop new color shades by combining with particular chromofore metals applied onto the ceramic body in form of water soluble organic salts.

Patent no. EP894081 discloses this kind of method to obtain a color shade from yellow to orange. Before forming the material, an amount of TiO₂ of 0.5 to 10% by weight is added to a traditional stoneware mass, and then an aqueous or hydroalcoholic solution of a Cr organic salt in combination with a Sb or Zn or Zr or Mn organic salt, or their mixtures, is applied onto the ceramic manufactured item. This process allows to obtain decorations on surface and to a depth of at least 1.6 mm. Patent application EP927710 describes a colour composition from ochre to yellow “Terra di Siena” for ceramic manufactured items containing 1% to 10% by weight of TiO₂, said composition being in form of an aqueous or hydroalcoholic solution comprising W or Cr organic derivatives. The addition of titanium dioxide strongly affects the development of colors not included in the aforesaid range of yellow and orange, that can be and obtained with known aqueous solutions of metal complexes, above all when these are used in a low concentration (or by serigraphy) to obtain soft colours.

For the pink colour the choice has been limited up to now to gold derivatives. The use of aqueous solutions of gold inorganic salts, for instance gold chloride, to colour with pink to violet shades ceramic surfaces has been known for quite a long time (see for instance “Encyclopedia der technischen Chemie”, 1929, vol. 4. pages 837-38 and DE 43.20.072). Said solutions show the disadvantage of being highly corrosive because of the presence of hydrochloric acid necessary to stabilize gold chloride in solution. DE 195.46.325 describes a method for colouring with a pink shade ceramic surfaces, characterized in that said ceramic surface is treated with an aqueous solution of an ammonium or alkali metal dithiosolphoaurate with a gold concentration of 0.1 to 10% by weight. Said solutions show the disadvantage of developing high amounts of pollutants (SO₂ and/or SO₃) during the firing cycle undergone by the decorated material. This disadvantage is overcome by using solutions quoted in the international patent application no. WO 00/10941. The above-mentioned patent application discloses the use of colouring composition which can colour on surface and to a depth of at least 1 mm with shades in the range from pink to purple to violet, consisting of aqueous solutions or mixtures of water and water soluble organic solvent of a gold thiolate having the general formula Au—S—R—X and Au—S—R—H, in which R is an aliphatic, aromatic, cycloaliphatic or etherocyclic, linear or branched, bivalent radical, possibly ethero-substituted.

Technical Problem

Considering the interest in the decoration with soluble salts, which can be used with simple and relatively cheap application methods, though allowing to obtain at the same time highly aesthetic products, such as disking and serigraphy, it is obvious that there is a strong interest of ceramic industry in finding new colouring compositions and new colouring processes compatible with said methods, broadening the chromatic range now available; in particular, there is a lack of colouring processes allowing to obtain pink/orange colors different from those which can be obtained with gold organic derivatives.

The technical problem which should be solved by said colouring processes is to use aqueous or hydroalcoholic solutions of organic metal complexes or inorganic metal salts which can easily be turned into coloured compounds stable at high temperatures, and to give the manufactured item, in particular stoneware, new pink/orange colors both on surface and within the ceramic body

### BRIEF DESCRIPTION OF THE FIGURES

FIG. 1 represents the values of the parameters a* and b* for a brightness value in the range L*=65-75 in the tests 1-63, for the raw manufactured items (see table 2 to 4).

FIG. 2 represents the values of the parameters a* and b* for a brightness value in the range L*=70-80, in the tests 1-63, for the smoothed manufactured items (see table 2 to 4).

### DESCRIPTION OF THE INVENTION

The applicant has found new colouring compositions and a new colouring method for ceramic materials, in particular stoneware, to obtain after firing new pink/orange shades on surface and within the ceramic body. Said new colouring compositions comprise aqueous or hydroalcoholic solutions of Cr inorganic salts or organic derivatives, or aqueous or hydroalcoholic solutions of Cr and Fe inorganic salts or organic derivatives, possible mixed with aqueous or hydroalcoholic solutions of Zn inorganic salts or organic derivatives, and they are proper to be applied onto a ceramic support suitably added with ZnO or zinc silicate, and suitably modified to compensate the excessive fusibility caused by zinc oxide or zinc silicate.

According to the present invention the addition of zinc oxide or zinc silicate to the ceramic mixture can be carried out by adding Zn oxide or silicate as such to the ceramic paste or by adding part of the Zn oxide or silicate to the ceramic mixture and then applying onto the ceramic surface an aqueous or hydroalcoholic solution of a “precursor”, meaning a Zn inorganic salt or organic derivative. Said precursor can be applied alone before or after the application of the colouring solution, or it can be mixed with the colouring solution itself.

The amount of ZnO to be added to the mixture according to the present invention is 5 to 20% by weight on the dry mixture, preferably 7 to 14% which corresponds to 4÷16% by w. and preferably 5.6÷11.25% of Zn (as element).

Alternatively, the stoneware ceramic mass can be added with such an amount of Zn silicate to introduce into the mixture an amount of Zn corresponding to the amount introduced by an addition of 5-20% of ZnO, that is 4-16% by w. of Zn.

Cr and Fe inorganic salts, in particular chlorides, nitrates, sulphates, chromates and dichromates, are particularly cheap and suitable to obtain the desired colours, but they have the disadvantage to give out corrosive gases or toxic vapors during firing. Therefore, it is preferred to use organic derivatives giving water and carbon dioxide by thermal decomposition.

Cr and Fe organic derivatives used in the present invention are salts of aliphatic or aromatic mono- or polycarboxylic acids having 1 to 18 carbon atoms, possibly with 1 to 5 substituents in the aliphatic chain, which can be hydroxy-, amino- or thio-substituents. As a mere non limiting example we can quote the following compounds: formic acid, acetic acid, propionic acid, butyric acid, lactic acid, glycolic acid, tartaric acid, citric acid, oxalic acid, maleic acid, fumaric acid, citraconic acid, gluconic acid, glycin, aminoadipic acid, aminobutyric acid, aminocaproic acid, aminocaprylic acid, 2-amino-4-hydroxybutyric acid, aminoisobutyric acid, aminolevulinic acid, thioglycolic acid, ethylendiaminotetraacetic acid (EDTA), salicylic acid. Among the organic derivatives used in the present invention let us remember polymers of polycarboxylic acids, such as polymers or copolymers of acrylic or metacrylic acid, and copolymers such as vinyl ether with maleic anhydride and acrolein.

Cr and Fe organic derivatives used in the present invention can possibly be used in form of ammonium salts or salts of an alkali metal.

Zn in form of chloride, nitrate or solphate can be used as a “precursor” for the development of ZnO, though the formation of corrosive gases during the firing stage of the decorated material makes it preferable to use as “precursors” Zn organic derivatives.

Zn organic derivatives used as “precursors” are salts of aliphatic or aromatic mono- or polycarboxylic acids having 1 to 18 carbon atoms, possibly with 1 to 5 substituents in the aliphatic chain, which can be hydroxy-, amino- or thio-substituents. As a mere non limiting example we can quote the following compounds: formic acid, acetic acid, propionic acid, butyric acid, lactic acid, glycolic acid, tartaric acid, citric acid, oxalic acid, maleic acid, fumaric acid, citraconic acid, gluconic acid, glycin, aminoadipic acid, aminobutyric acid, aminocaproic acid, aminocaprylic acid, 2-amino-4-hydroxybutyric acid, aminoisobutyric acid, aminolevulinic acid, thioglycolic acid, ethylendiaminotetraacetic acid (EDTA), salicylic acid. Among the organic derivatives used in the present invention let us remember polymers of polycarboxylic acids, such as polymers or copolymers of acrylic or metacrylic acid, and copolymers such as vinyl ether with maleic anhydride and acrolein.

Said Zn organic derivatives can possibly be used in form of ammonium salts or alkali metal salts.

Colouring compositions according to the present invention allow to obtain a coloration on surface and to a variable depth up to 2 mm within the ceramic body.

The obtained colors depend on the concentration of Cr and Fe in solution, on the weight relation Cr/Fe, on the amount of applied solution by surface unit and on the Zn content added to the ceramic mixture in form of oxide, silicate and in form of “precursor”.

Aqueous or hydroalcoholic colouring compositions according to the present invention contain 0.4% to 12% by weight of Cr (stated as element), preferably 4 to 9%; the concentration of Fe in the colouring solutions containing Cr and Fe should be such that the weight relation Cr/Fe (stated as elements) in solution is between 1:2 and 9:1, preferably from 1:1 to 4:1.

Aqueous or hydroalcoholic solutions of Zn organic derivatives used as “precursors” according to the present invention contain 0.5 to 14% by weight of Zn (stated as element), preferably from 6 to 12%. Aqueous solutions of Zn inorganic salts used as “precursors” contain 0.5 to 40% of Zn. If the “precursor” is used in combination with the colouring solutions containing Cr or Cr and Fe according to the present invention, the weight relation Cr/Zn (stated as elements) is between 1:5 and 5:1.

A method for the application of the colouring compositions according to the present invention includes the following stages:

a) preparation of a stoneware ceramic mass containing 5 to 20% by dry weight (preferably 7 to 14%) of ZnO;

b) drying of the formed ceramic body at room temperature or higher up to 100° C., up to a water residual content below 0.5% by weight;

c) treatment of the surface with an aqueous or hydroalcoholic solution of Cr or Cr and Fe organic complexes or inorganic salts, possibly containing the “precursor”, in an amount of solution of 20 to 600 g/m² of final coloured surface;

d) balancing of the object coming from the previous stage at room temperature, or higher up to 70° C., for at least 1 hour, to homogenize solution absorption;

e) oven firing following a standard ceramic cycle for glazed stoneware.

Alternatively, stage a) of said method provides for the preparation of a stoneware ceramic mixture added with zinc silicate in such an amount to introduce into said mixture an amount of Zn corresponding to the amount introduced by an addition with 5-20% of ZnO.

Before, after or during stage c) of the process according to the invention the ceramic surface can be treated with an aqueous or hydroalcoholic solution of the “precursor” in an amount of 20 to 600 g/m² of final coloured surface. Said treatment can be carried out with a single solution application or with several applications. An additional drying stage of the ceramic manufactured item can be provided between each application.

The amount of colouring solution to be applied before firing onto the ceramic material added with ZnO or zinc silicate should be such to ensure by means of the application of colouring solutions in an amount of 20 to 600 g/m² of final coloured surface the application of 1 to 50 g/m² of Cr (stated as element), preferably 2 to 36 g/m², and of 0.5 to 50 g/m² of Fe (stated as element), preferably 4 to 40 g/m². If the “precursor” is used in combination with the colouring solutions containing Cr or Cr and Fe according to the present invention, the amount of colouring solution to be applied should be such to ensure the application of 1 to 50 g/m² of Zn (stated as element), preferably 5 to 40 g/m².

Aqueous or hydroalcoholic solutions according to the present invention can be applied onto the ceramic material by several methods, such as by dipping, spraying and disk spraying. Moreover, said solutions can be thickened to form a paste suitable for application onto the ceramic surface by serigraphy; thickeners which can be used are for instance natural or industrial starches or rubbers in an amount up to 8%. The application by serigraphy allows to obtain ceramic manufactured items with complex decorations, in which the solutions according to the present invention are applied until said ceramic manufactured item is wholly or partly decorated. The following operating stages are optional for the implementation of the method described above:

between stage b) and c) the dried object undergoes a pre-treatment with water up to a maximum amount of 300 g/m² of the ceramic material;

between stage c) and d) the dried object undergoes a post-treatment water up to a maximum amount of 300 g/m² of the ceramic material.

The addition of ZnO or zinc silicate to the stoneware mixture according to the present invention takes place within the whole ceramic body, by mixing the oxide or silicate to the raw materials commonly used before these are conveyed to the grinding or forming devices, according to a process known as “whole mass”. Alternatively, ZnO or zinc silicate are added to a small percentage of the mixture, which is deposited during the forming stage onto a base made of traditional stoneware paste, according to the method known as “double feeding”. Thus only the surface layer of the ceramic body which has to be coloured is enriched with Zn, where the thickness of the added layer can be adjusted to the requirements of further processing of the ceramic manufactured item.

Independently from the method used to add ZnO or zinc silicate to the mixture to carry out the process according to the present invention, the traditional paste composition should be suitably varied to balance the introduction of zinc oxide or silicate. Zinc oxide and silicate exert a melting action into the mixture, thus enabling during firing the formation of extended glass phases and resulting in melted materials after firing. A high percentage of zinc oxide or zinc silicate in the ceramic mixture should therefore be suitably balanced with the introduction into said mixture of refractory materials, which resist thermo-mechanical stresses up to temperatures above those reached in a standard firing cycle. Examples of said refractory materials are pyrophyllite, kaolin, zirconium silicate, zirconium oxide, alumina and quartz. The use of zirconium silicate to balance the fusibility of zinc oxide or zinc silicate, though being expensive with respect to other compounds such as quartz, has proved interesting in the implementation of the process according to the invention, since it has been found that, beyond having the necessary qualities of a refractory material, said material contributes to the increase of brilliance of the pink/orange shades obtained using colouring solutions according to the present invention.

Alternatively, the presence of high percentages of melting material can be balanced by completely re-formulating the ceramic mixture, by varying the proportions of all raw materials so as to obtain a balanced mixture which shows after firing a water absorption below 0.5%, as in the case of normal stoneware.

According to a main feature of the present invention it is possible to mix aqueous or hydroalcoholic colouring solutions of Au, Co, Ni, Mn, Pd, Ru, V and Zr organic complexes known in the art to obtain colors or color shades which are different from those which can be normally obtained with traditional mixtures, i.e. which are not added with ZnO or zinc silicate. The mixtures thus obtained can be applied according to the method described above.

### EXAMPLES

### Example 1

### Colorations with Pink to Pink/Orange Shades Developed from the Colouring Compositions According to the Invention

100 g of a paste whose composition is shown in Table 1 are added with 15 g of ZnO and 5 g of quartz (to balance the fusibility of Zn oxide) before the forming stage; the formed material is dried at 100° C. up to a water residual content below 0.5% by weight. The surface is treated at room temperature with an aqueous solution of acetated Cr (tests 1-2), with an aqueous solution of Cr acetate and Zn acetate (tests 3 to 11), with an aqueous solution of Cr acetate and Fe citrate (tests 12 to 29), in an amount of 450 g/m² of final coloured surface. The decorated ceramic body is fired in an industrial oven with a standard fast firing cycle for stoneware (40 min. cycle, maximum temperature 1210° C.). The tile is smoothed to an average depth of 0.75 mm.

TABLE 1
Chemical analysis of the mixture used:
per cent composition before addition

| SiO₂ | Al₂O₃ | Fe₂O₃ | TiO₂ | CaO | MgO | Na₂O | K₂O |
|---|---|---|---|---|---|---|---|
| 66.7 | 21.0 | 0.69 | 0.39 | 0.50 | 0.66 | 3.23 | 2.42 |

Colour measurements are carried out according L*a*b* system. In this calorimetric space L* indicates brightness and is a value varying from 0 and 100 (0 is black, 100 white), whereas a* and b* are the chromatic coordinates, in which a* is the component red(+a*)/green(−a*) and b* the component yellow(+b*)/blue(−b*). Each color is identified by the value of these three parameters. Color measurements are carried out with a Spectrapen Model DrLange calorimeter (LZM224-Standard no. 1009).

Table 2 shows L*a*b* values obtained; the concentration of the solutions is expressed as % by weight of the metals.

TABLE 2

| | | | | RAW | | | SMOOTHED | | |
|---|---|---|---|---|---|---|---|---|---|
| Test no. | % Cr | % Zn | % Fe | L* | a* | b* | L* | a* | b* |
| 1 | 4.4 | | | 65.68 | 8.96 | 19.07 | 73.5 | 7.53 | 13.68 |
| 2 | 2.2 | | | 71.92 | 8.95 | 18.00 | 80.62 | 5.17 | 11.89 |
| 3 | 6.16 | 2.4 | | 59.86 | 6.81 | 17.01 | 69.63 | 12.15 | 17.36 |
| 4 | 4.4 | 4.0 | | 66.76 | 8.26 | 17.55 | 75.47 | 7.68 | 13.88 |
| 5 | 2.64 | 5.6 | | 71.34 | 9.35 | 18.06 | 79.71 | 5.51 | 12.23 |
| 6 | 1.32 | 2.8 | | 75.60 | 7.80 | 16.55 | 83.67 | 3.08 | 9.41 |
| 7 | 2.9 | 2.0 | | 71.90 | 9.21 | 17.93 | 82.23 | 3.84 | 10.33 |
| 8 | 3.08 | 1.2 | | 69.59 | 9.74 | 18.50 | 81.86 | 4.05 | 10.48 |
| 9 | 0.66 | 1.4 | | 78.76 | 5.58 | 15.17 | 85.01 | 2.12 | 8.34 |
| 10 | 1.1 | 1.0 | | 75.52 | 7.79 | 17.43 | 84.18 | 2.68 | 9.01 |
| 11 | 1.54 | 0.6 | | 73.62 | 8.72 | 18.13 | 83.56 | 3.01 | 9.38 |
| 12 | 7.92 | | 1.0 | 38.20 | 4.91 | 7.30 | 58.84 | 15.01 | 22.98 |
| 13 | 3.96 | | 0.5 | 63.73 | 11.05 | 22.93 | 74.24 | 7.94 | 16.89 |
| 14 | 1.98 | | 0.25 | 70.59 | 9.84 | 21.74 | 80.84 | 4.26 | 12.07 |
| 15 | 7.04 | | 2.0 | 36.82 | 5.41 | 6.83 | 61.07 | 13.21 | 22.41 |
| 16 | 3.52 | | 1.0 | 62.94 | 12.01 | 24.90 | 76.67 | 6.19 | 15.58 |
| 17 | 1.76 | | 0.5 | 69.55 | 10.26 | 23.94 | 81.38 | 3.58 | 11.84 |
| 18 | 6.16 | | 3.0 | 34.66 | 5.61 | 6.62 | 59.55 | 13.69 | 24.76 |
| 19 | 3.08 | | 1.5 | 63.79 | 11.95 | 25.65 | 76.92 | 5.68 | 15.44 |
| 20 | 1.54 | | 0.75 | 68.71 | 10.64 | 24.98 | 80.96 | 3.49 | 12.32 |
| 21 | 5.28 | | 4.0 | 33.86 | 7.67 | 8.53 | 61.30 | 12.71 | 26.12 |
| 22 | 2.64 | | 2.0 | 61.53 | 12.51 | 27.09 | 76.42 | 5.36 | 16.13 |
| 23 | 1.32 | | 1.0 | 68.53 | 10.46 | 26.15 | 81.66 | 2.75 | 11.47 |
| 24 | 4.4 | | 5.0 | 33.96 | 8.54 | 9.93 | 63.78 | 11.08 | 22.70 |
| 25 | 2.2 | | 2.5 | 62.56 | 11.96 | 27.35 | 77.93 | 4.28 | 15.20 |
| 26 | 1.1 | | 1.25 | 68.87 | 9.52 | 25.94 | 81.96 | 2.39 | 11.12 |
| 27 | 3.52 | | 6.0 | 35.00 | 10.86 | 13.16 | 63.57 | 10.46 | 25.64 |
| 28 | 1.76 | | 3.0 | 62.77 | 11.41 | 27.84 | 78.87 | 3.58 | 14.28 |
| 29 | 0.88 | | 1.5 | 69.00 | 8.59 | 25.94 | 82.35 | 2.10 | 10.80 |

### Example 2

### Comparison with Colorations Obtained from Known Solutions and Methods

(a) Gold-Based Pink

In order to obtain a pink shade by means of known colouring solutions based on gold, a tile is used, which is made of a paste whose composition is shown in Table 1; said tile is pressed, dried in a stove at 100° C. up to a water residual content below 0.5%, treated with colouring solutions in an amount of 450 m²/g and then fired in an oven according to a standard fast firing cycle for stoneware (40 min. cycle, maximum temperature 1210° C.). The following colouring solutions are used:

tests 30-33: Au-mercaptosuccinate aqueous solutions according to the method described in the patent application WO 00/10941;

tests 34-47: NaAuCl₄ aqueous solutions obtained by dilution from a mother solution prepared by neutralizing with NaOH up to pH=2.7 the amount of HAuCl₄ necessary to obtain a solution with 0.4% by weight of Au;

tests 38-42: Au-acetylcysteinate aqueous solutions according to the method described in the patent application WO 00/10941.

Tiles are smoothed up to an average depth of 0.75 mm.

Measurements of the obtained colors, shown in Table 3, are carried out with L*a*b* system as previously disclosed; the concentration of the solutions is expressed as % by weight of the metals.

TABLE 3

| | | RAW | | | SMOOTHED | | |
|---|---|---|---|---|---|---|---|
| Test no. | % Au | L* | a* | b* | L* | A* | b* |
| 30 | 0.8 | 46.07 | 14.27 | 4.64 | 79.73 | 2.37 | 8.29 |
| 31 | 0.6 | 47.08 | 14.71 | 5.18 | 80.19 | 2.1 | 8.68 |
| 32 | 0.4 | 47.66 | 14.85 | 6.33 | 80.12 | 2.11 | 8.62 |
| 33 | 0.2 | 50.12 | 14.69 | 6.24 | 81.69 | 1.16 | 9.33 |
| 34 | 0.4 | 66.11 | 11.82 | 4.51 | 74.02 | 5.98 | 5.55 |
| 35 | 0.3 | 68.02 | 10.94 | 4.71 | 74.09 | 5.87 | 5.82 |
| 36 | 0.2 | 72.32 | 8.64 | 4.88 | 76.69 | 4.53 | 6.62 |
| 37 | 0.1 | 78.79 | 4.81 | 6.23 | 79.19 | 2.89 | 7.76 |
| 38 | 1.0 | 39.56 | 15.21 | 10.87 | 59.23 | 12.61 | 2.74 |
| 39 | 0.75 | 38.74 | 16.63 | 9.90 | 61.44 | 11.71 | 2.92 |
| 40 | 0.50 | 40.90 | 17.42 | 8.38 | 66.03 | 9.80 | 3.79 |
| 41 | 0.25 | 46.70 | 19.06 | 4.76 | 73.59 | 6.34 | 5.69 |
| 42 | 0.10 | 59.69 | 15.86 | 3.62 | 76.99 | 4.36 | 6.92 |

(b) Yellows Obtained with Known Methods

To obtain yellow colors the following process is followed: a tile made of the ceramic mass shown in Table 1, added with 2% of TiO₂ (total TiO₂ 2.39%) is pressed, dried in a stove at 100° C. up to a residual water content below 0.5%, treated with colouring solutions in an amount of 450 g/m² and eventually fired in an oven according to a standard firing cycle for stoneware (40 min. cycle, maximum temperature 1210° C.). The following colouring solutions have been used:

tests 43-47: aqueous solutions of Sb tartrate and Cr acetate according to the method described in EP 894.081 at various concentrations;

tests 48-58: aqueous solutions of Zn acetate and Cr acetate according to the method described in EP 894.081 at various concentrations;

tests 59.63: aqueous solutions of W citrate and Cr citrate according to the method described in EP 927.710 at various concentrations.

Tiles are smoothed up to an average depth of 0.75 mm.

Measurements of the obtained colors, shown in Table 4, are carried out with L*a*b* system as previously disclosed; the concentration of the solutions is expressed as % by weight of the metals.

TABLE 4

| | | | | | RAW | | | SMOOTHED | | |
|---|---|---|---|---|---|---|---|---|---|---|
| Test no. | % Sb | % Cr | % Zn | % W | L* | a* | b* | L* | a* | b* |
| 43 | 15.2 | 0.44 | | | 74.44 | 5.09 | 28.36 | 79.08 | 3.23 | 31.41 |
| 44 | 12.8 | 1.76 | | | 63.09 | 8.65 | 30.75 | 70.84 | 8.41 | 39.08 |
| 45 | 6.4 | 0.88 | | | 69.03 | 8.62 | 33.60 | 76.00 | 4.52 | 34.39 |
| 46 | 3.2 | 0.44 | | | 71.43 | 8.25 | 35.84 | 78.32 | 2.32 | 30.42 |
| 47 | 1.28 | 0.18 | | | 74.51 | 6.89 | 37.51 | 80.53 | 0.20 | 20.47 |
| 48 | | 2.64 | 1.60 | | 58.43 | 4.63 | 23.77 | 71.76 | 3.38 | 23.75 |
| 49 | | 1.10 | 1.00 | | 65.59 | 6.10 | 26.01 | 76.53 | 1.98 | 20.33 |
| 50 | | 1.32 | 0.80 | | 62.62 | 5.59 | 25.26 | 75.72 | 2.13 | 20.98 |
| 51 | | 1.54 | 0.60 | | 60.17 | 4.34 | 22.97 | 74.59 | 2.34 | 21.86 |
| 52 | | 1.76 | 0.40 | | 58.58 | 3.40 | 21.89 | 73.79 | 2.60 | 22.31 |
| 53 | | 1.98 | 0.20 | | 57.93 | 3.01 | 21.50 | 71.96 | 2.90 | 23.29 |
| 54 | | 0.44 | 0.40 | | 71.36 | 4.99 | 27.22 | 79.23 | 0.96 | 16.92 |
| 55 | | 0.53 | 0.32 | | 68.56 | 5.48 | 27.63 | 78.83 | 1.19 | 17.95 |
| 56 | | 0.62 | 0.24 | | 67.15 | 5.34 | 26.00 | 78.31 | 1.39 | 18.34 |
| 57 | | 0.70 | 0.16 | | 61.31 | 4.28 | 23.35 | 75.44 | 2.16 | 21.43 |
| 58 | | 0.79 | 0.08 | | 63.28 | 4.34 | 24.05 | 76.71 | 1.79 | 20.32 |
| 59 | | 0.33 | | 6.75 | 68.58 | 7.34 | 29.19 | 75.49 | 2.87 | 30.12 |
| 60 | | 0.17 | | 3.38 | 74.58 | 3.96 | 27.56 | 80.80 | 0.01 | 18.50 |
| 61 | | 1.00 | | 5.25 | 63.49 | 10.81 | 30.51 | 71.56 | 6.27 | 33.94 |
| 62 | | 0.50 | | 2.62 | 70.18 | 7.83 | 30.87 | 78.82 | 1.08 | 22.62 |
| 63 | | 0.67 | | 1.88 | 67.26 | 9.41 | 31.22 | 76.97 | 2.28 | 25.71 |

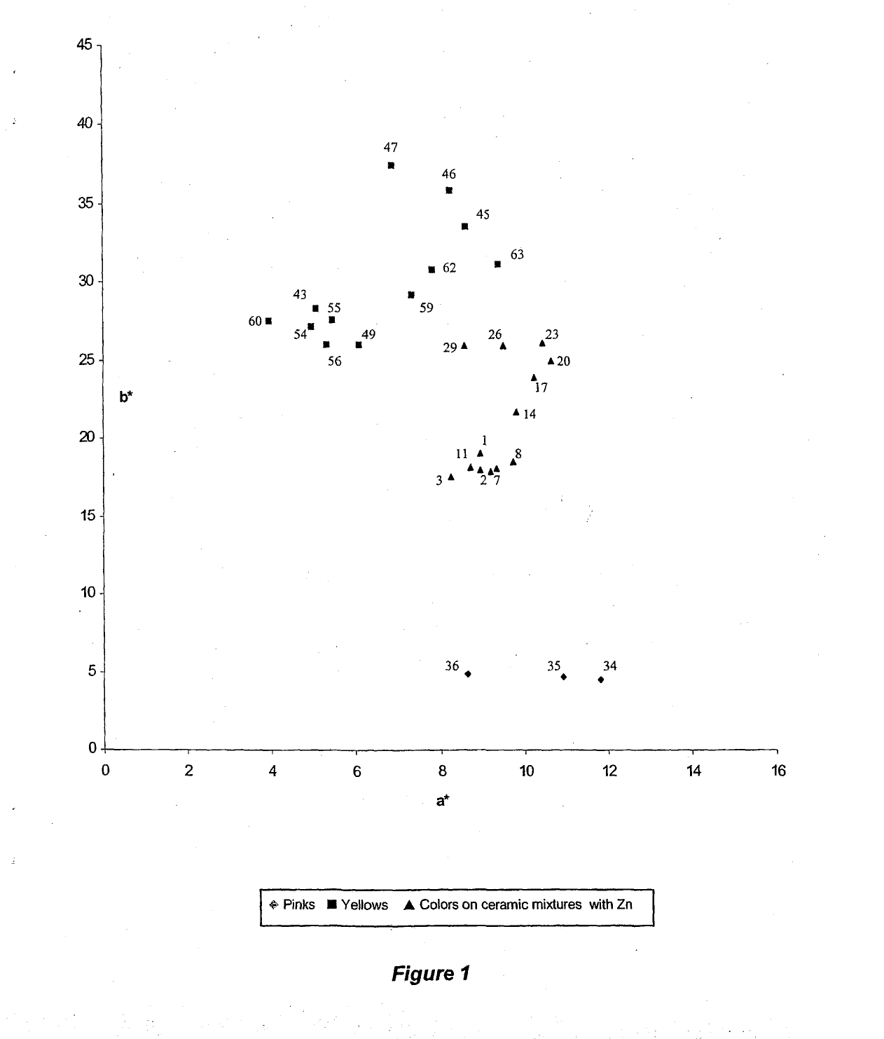

To make even more evident the difference between the yellow and pink colors which can be obtained by means of solutions and processes known at the state of the art, and the pink/orange shades which can be obtained by means of the new colouring process, the calorimetric data shown in tables 2, 3 and 4 can be graphically represented as dots by drawing on a plane orthogonal to axis L* the projection on said plane of a* and b* values. For the representation shown in FIG. 1 a portion of the calorimetric space L*a*b* in a brightness range L*=65-75 is chosen and the diagram shows the dots corresponding to the colors having L* values within the considered range on the raw manufactured item.

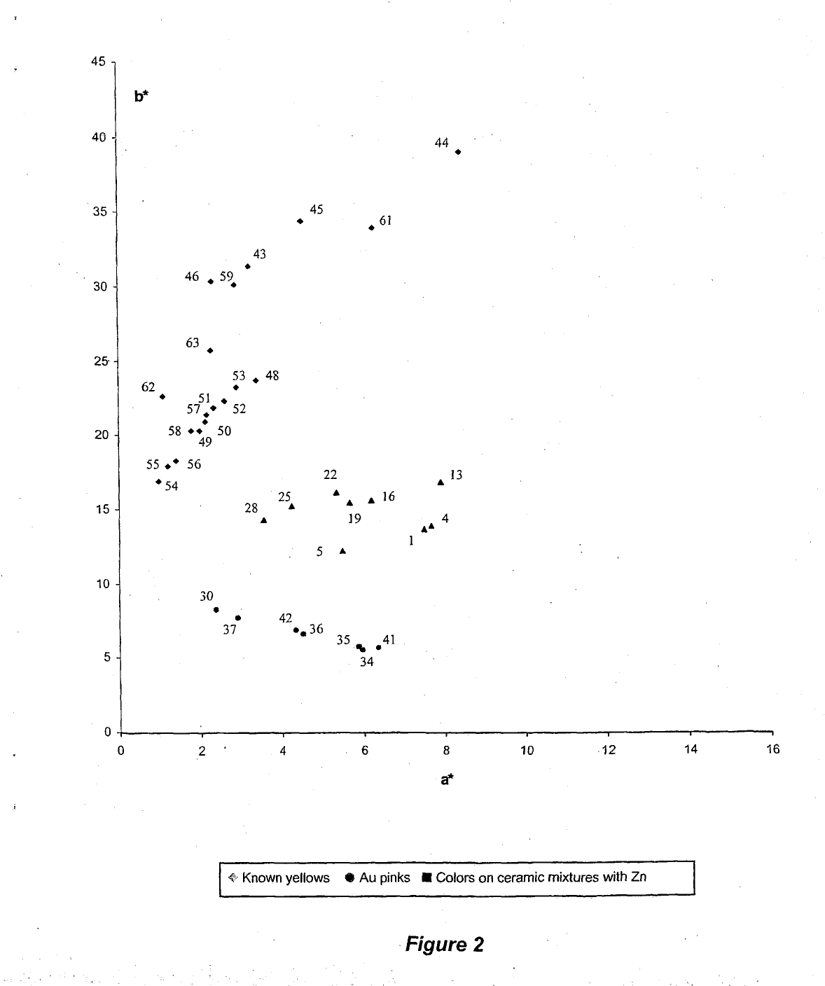

Similarly, in FIG. 2 a portion of the calorimetric space L*a*b* in a brightness range L*=70-80 is chosen and the diagram shows the dots corresponding to the colours having L* values of 70 to 80 on the smoothed manufactured item.

### Comparative Example 3

### Comparison with Colours Developed from Cr, Cr/Fe and Cr/Zn Solutions on Traditional Ceramic Mixtures

The surface of a tile made of a traditional mixture, whose composition is shown in Table 1, is treated with an aqueous solution of Cr acetate (tests 64-65), or with an aqueous solution of Cr acetate and Zn acetate (tests 66-71), or with an aqueous solution of Cr acetate and Fe citrate (tests 72-77), in an amount of 450 g/m² of final coloured surface. The decorated ceramic body is fired in an industrial oven with a standard fast firing cycle for stoneware (40 min. cycle, maximum temperature 1210° C.).

Measurements of the obtained colours, shown in Table 5 for the raw manufactured item and in Table 6 for the smoothed manufactured item, are carried out with L*a*b* system as previously disclosed; the concentration of the solutions is expressed as % by weight of the metals. Said tables also show by way of comparison L*a*b* values obtained in Example 1 for solutions having the same concentration on tiles added with 15 g of ZnO.

TABLE 5
Raw manufactured items.

| | | | Traditional mixture | | | | | Mixture with ZnO (Example 1) | | | | |
|---|---|---|---|---|---|---|---|---|---|---|---|---|
| | O% | % | Test | | | | | Test | | | | |
| % Cr | Zn | Fe | no. | Color | L* | A* | b* | no. | Color | L* | a* | b* |
| 4.4 | | | 64 | Olive green | 48.13 | −0.91 | 14.10 | 1 | Beige pink | 65.68 | 8.96 | 19.07 |
| 2.2 | | | 65 | Olive green | 47.48 | −1.09 | 14.85 | 2 | Flesh pink | 71.92 | 8.95 | 18.00 |
| 6.16 | 2.4 | | 66 | Olive green | 47.97 | −2.42 | 13.28 | 3 | Hazel-pink | 59.86 | 6.81 | 17.01 |
| 4.4 | 4.0 | | 67 | Beige green | 54.41 | 3.81 | 16.15 | 4 | Dark flesh pink | 66.76 | 8.26 | 17.55 |
| 2.9 | 2.0 | | 68 | Dark beige | 58.51 | 5.17 | 18.73 | 7 | Flesh pink | 71.9 | 9.21 | 17.93 |
| 3.08 | 1.2 | | 69 | Olive green | 52.30 | 0.33 | 14.20 | 8 | Flesh pink | 69.59 | 9.74 | 18.50 |
| 1.1 | 1.0 | | 70 | Dark beige | 58.59 | 5.10 | 18.63 | 10 | Flesh pink | 75.52 | 7.79 | 17.43 |
| 1.54 | 0.6 | | 71 | Beige green | 52.06 | 0.38 | 14.10 | 11 | Flesh pink | 73.62 | 8.72 | 18.13 |
| 6.16 | | 3.0 | 72 | Dark brown | 32.88 | 3.80 | 4.66 | 18 | Dark brown | 34.66 | 5.61 | 6.62 |
| 1.54 | | 0.75 | 73 | Hazel-brown | 49.63 | 6.73 | 18.08 | 20 | Orange pink | 68.71 | 10.64 | 24.98 |
| 5.28 | | 4.0 | 74 | Dark brown | 32.81 | 6.26 | 7.73 | 21 | Brown | 33.86 | 7.67 | 8.53 |
| 1.32 | | 1.0 | 75 | Hazel-brown | 48.85 | 8.31 | 17.99 | 23 | Orange pink | 68.53 | 10.46 | 26.15 |
| 4.4 | | 5.0 | 76 | Dark brown | 32.68 | 7.48 | 8.49 | 24 | Brown | 33.96 | 8.54 | 9.93 |
| 1.1 | | 1.25 | 77 | Hazel-brown | 47.08 | 9.47 | 17.40 | 26 | Orange pink | 68.87 | 9.52 | 25.94 |

TABLE 6
Smoothed manufactured items.

| | | | Traditional mixture | | | | | Mixture with ZnO (Example 1) | | | | |
|---|---|---|---|---|---|---|---|---|---|---|---|---|
| | | | Test | | | | | Test | | | | |
| % Cr | % Zn | % Fe | no | Color | L* | a* | b* | no. | Color | L* | a* | b* |
| 4.4 | | | 64 | Beige green | 67.84 | 2.97 | 17.43 | 1 | Pastel pink | 73.50 | 7.53 | 13.68 |
| 2.2 | | | 65 | Beige | 75.23 | 1.95 | 15.39 | 2 | Soft pink | 80.62 | 5.17 | 11.89 |
| 6.16 | 2.4 | | 66 | Beige green | 56.06 | 2.67 | 16.67 | 3 | Flesh pink | 69.63 | 12.15 | 17.36 |
| 4.4 | 4.0 | | 67 | Beige green | 63.70 | 3.77 | 18.23 | 4 | Flesh pink | 75.47 | 7.68 | 13.88 |
| 2.9 | 2.0 | | 68 | Beige | 73.26 | 2.36 | 16.29 | 7 | Soft pink | 82.23 | 3.84 | 10.33 |
| 3.08 | 1.2 | | 69 | Intense beige | 70.07 | 2.89 | 17.36 | 8 | Soft pink | 81.86 | 4.05 | 10.48 |
| 1.1 | 1.0 | | 70 | Light beige | 77.44 | 1.59 | 13.99 | 10 | Soft pink | 84.18 | 2.68 | 9.01 |
| 1.54 | 0.6 | | 71 | Beige | 76.27 | 1.71 | 14.67 | 11 | Soft pink | 83.56 | 3.01 | 9.38 |
| 6.16 | | 3.0 | 72 | Brown | 44.02 | 7.11 | 17.70 | 18 | Orange pink | 59.55 | 13.69 | 24.76 |
| 1.54 | | 0.75 | 73 | Beige | 75.49 | 1.78 | 15.03 | 20 | Pale pink | 80.96 | 3.49 | 12.32 |
| 5.28 | | 4.0 | 74 | Brown | 44.36 | 7.73 | 17.39 | 21 | Orange pink | 61.30 | 12.71 | 26.12 |
| 1.32 | | 1.0 | 75 | Beige | 75.88 | 1.77 | 14.85 | 23 | Pale pink | 81.66 | 2.75 | 11.47 |
| 4.4 | | 5.0 | 76 | Brown | 41.70 | 8.67 | 17.15 | 24 | Orange pink | 63.78 | 11.08 | 22.70 |
| 1.1 | | 1.25 | 77 | Beige | 75.58 | 1.77 | 14.89 | 26 | Pale pink | 81.96 | 2.39 | 11.12 |

1. Process for obtaining manufactured ceramic articles coloured on surface and inside at variable depth up to 2.5 mm, with pink-orange shades, from a stoneware mass, added before moulding with a Zn inorganic compound selected from Zn oxide or Zn silicate, in an amount corresponding to 4%÷16% by w. of Zn (as element) on dry weight and by the treatment of the moulded article before firing with an aqueous or hydroalcoholic solution of Cr or Cr and Fe or Cr and Zn or Cr, Fe and Zn inorganic salts or organic derivatives, the amount of said solution used in the treatment being comprised between 20 and 600 g/m² of final coloured surface.

2. Process according to claim 1 wherein the treatment of the moulded article before filing is carried out with a solution containing 0.4 to 12% by w. of Cr/stated as element).

3. Process according to claim 1 wherein the treatment solution contains Cr and Fe in a weight ratio Cr/Fe between 1:2 and 9:1.

4. Process according to claim 1 wherein the treatment solution contains Cr and Zn in a weight ratio Cr/Zn between 1:5 and 5:1.

5. Process according to claim 1, in which Cr, Fe and Zn organic derivatives are organic salts of aliphatic or aromatic mono- or polycarboxylic acids having 1 to 18 carbon atoms, possibly with 1 to 5 substituents in the aliphatic chain, which can be hydroxy-, amino or thio-groups.

6. Process according to claim 1, characterized in that Cr, Fe and Zn organic derivatives are salts of the following acids: formic acid, acetic acid, propionic acid, butyric acid, lactic acid, glycolic acid, tartaric acid, citric acid, oxalic acid, maleic acid, fumaric acid, citraconic acid, gluconic acid, glycin, aminoadipic acid, aminobutyric acid, aminocaproic acid, aminocaprylic acid, 2-amino-4-hydroxybutyric acid, aminoisobutyric acid, aminolevulinic acid, thioglycolic acid, ethylendiaminotetraacetic acid (EDTA), salicylic acid.

7. Process according to claim 1, characterized in that Cr, Fe and Zn organic derivatives are in form of ammonium salts or salts of an alkali metal.

8. Process for obtaining ceramic manufactured articles according to claim 1, characterized by the following operative steps:
a) addition of ZnO or Zn silicate to the stoneware ceramic mass;
b) drying of the formed ceramic body at room temperature or higher up to 100° C., up to a water residual content below 0.5% by weight;
c) treatment of the surface with an aqueous or hydroalcoholic solution of Cr or Cr and Fe or Cr and Zn or Cr, Fe and Zn inorganic salts or organic derivatives, in an amount of solution of 20 to 600 g/m² of final coloured surface;
d) balancing of the object coming from the previous stage for 8 hours at room temperature, or higher up to 70° C., for at least 1 hour, to homogenize solution absorption;
e) oven firing following a standard ceramic cycle for glazed stoneware.

9. Process according to claim 8, characterized in that between step b) and c) the dried object undergoes a pre-treatment with water up to a maximum amount of 300 g/m² of ceramic material.

10. Process according to claim 8, characterized in that between stage c) and d) the dried object undergoes a post-treatment with water up to a maximum amount of 300 g/m² of ceramic material.

11. Process according to claim 8, in which before, after or during step c) the ceramic surface is treated with an aqueous or hydroalcoholic solution of Zn inorganic salts or organic derivatives in an amount of 20 to 600 g/m² of final coloured surface.

12. Process according to claim 11, characterized in that Zn organic derivatives which are used are organic salts of aliphatic or aromatic mono- or polycarboxylic acids having 1 to 18 carbon atoms, possibly with 1 to 5 substituents in the aliphatic chain, which can be hydroxy-, amino- or thio-groups.

13. Process according to claim 12, characterized in that Zn organic salts which are used are in form of ammonium salts or salts of an alkali metal.

14. Process according to claim 11, characterized in that the concentration of the aqueous or hydroalcoholic solutions of Zn organic derivatives is of 0.5 to 14% by weight of Zn (stated as element), preferably 6 to 12%.

15. Process according to claim 11, characterized in that the concentration of the solutions of Zn inorganic salts is of 0.5 to 40% by weight of Zn (stated as element).

16. Ceramic manufactured articles, wholly or partly decorated with the method according to claims 1 to 15.
